(19) United States
(12) Patent Application Publication
(10) Pub. No.: US 2005/0171371 A1
(43) Pub. Date: Aug. 4, 2005

(54) Method for the reduction of binaphthyl derivatives

(76) Inventors: Armin Borner, Rostock (DE); Andrei Korostylev, Ryazan (RU); Vitali Tararov, Moscow (RU); Axel Monsees, Frankfurt (DE)

Correspondence Address: FITCH, EVEN, TABIN & FLANNERY, P. O. BOX 65973, WASHINGTON, DC, 20035, US

(21) Appl. No.: 10/968,458

(22) Filed: Oct. 20, 2004

(30) Foreign Application Priority Data
Oct. 21, 2003 (DE) 103 49 399.9

(51) Int. Cl. C07F 7/04

(52) U.S. Cl. 556/446; 564/428

(57) ABSTRACT

The present invention relates to a method for the preparation of H₈-1,1′-bi-2-naphthyl derivatives of the formula (II) 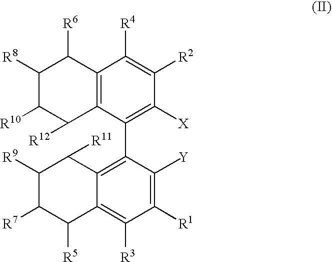 by reduction of the corresponding binaphthyl derivatives by hydrogen in the presence of a catalyst containing at least one metal selected from the group Pt, Ir, Os, Pd, Rh, Ru, Ni, Co and Fe applied to a solid support.

### CROSS REFERENCE TO RELATED APPLICATIONS

The present application claims priority to German application no. 103 49 399.9, filed Oct. 21, 2003, which is incorporated in its entirety herein by reference.

### FIELD OF THE INVENTION

The present invention is directed to a method for the selective reduction of binaphthyl derivatives with hydrogen.

### BACKGROUND OF THE INVENTION

2,2′-Functionalized 1,1′-bi-2-naphthyl derivatives, for example BINOL (1,1′-bi-2-naphthol) or BINAM (1,1′-bi-2-naphthylamine), can be used as chiral ligands in asymmetric catalysis. Ligands based on an Hg-binaphthyl backbone are of particular interest since these ligands frequently exhibit relatively high asymmetric induction. Thus, enantiomerically pure H₈-1,1′-bi-2-naphthols or H₈-1,1′-bi-2-naphthylamines are highly sought after either for use as ligands or as starting compounds for derivatization.

H₈-1,1′-Bi-2-naphthyl derivatives are obtainable by reduction of the corresponding 2,2′-functionalized 1,1′-bi-2-naphthyl derivatives. Generally, a method developed by Cram, et al. (Angew. Chem. 113(8): 1500-1504 (2001)) is used in which the reduction is performed using a PtO₂ catalyst in the presence of acetic acid. To carry out the method, relatively large amounts of catalyst are required. In addition, the reaction must be performed at very low temperatures to maintain enantioselectively and this leads to long reduction times.

Another reduction method is described by Hui Guo, et al. (Tetrahedron Lett. 41: 10061-10064 (2000)) which utilizes a Raney Ni/Al catalyst in an aqueous alkaline isopropanol solution. As in the Cram et al method, long reaction times are needed and yields are relatively low.

### DESCRIPTION OF THE INVENTION

The object of the present invention was to provide a method for preparing H₈-1,1′-bi-2-naphthyl derivatives with high selectivity, in which the desired products can be obtained with good yields. This is achieved by catalytic reduction of binaphthyls with hydrogen using a catalyst containing at least one metal from subgroup eight applied to a solid support.

The present invention therefore relates to a method for the reduction of binaphthyl derivatives of the formula (I), 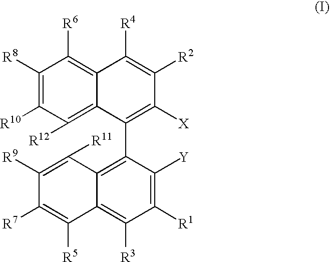
with hydrogen to give H₈-1,1′-bi-2-naphthyl derivatives (5,5′,6,6′,7,7′,8,8′-octahydro-1,1′-dinaphthyl derivatives) of the formula (II)

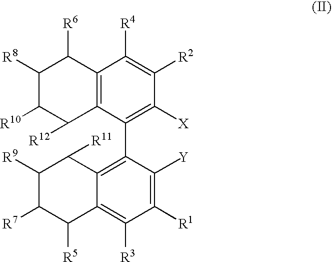

Reduction reactions are carried out in the presence of a catalyst containing at least one metal selected from the group Pt, Ir, Os, Pd, Rh, Ru, Ni, Co and Fe. The metal or the metals should preferably be applied to a solid support.

X and Y are, independently of one another, a radical selected from the group OH, OR′, O—((CₙH₂ₙ)—O—)ₘR′, NH₂, NHR′, NR′R″, SH and SR′, where R′ and R″ independently of one another are a hydrogen, (C₁-C₂₄)-alkyl, (C₃-C₁₂)-cycloalkyl, (C₂-C₂₄)-alkenyl, (C₃-C₂₄)-cycloalkenyl or (C₅-C₂₀)-aryl radical. The radicals R′ and R″ can also bear other substituents. n is an integer from 1 to 24, preferably from 1 to 6, and m is an integer from 1 to 12, preferably from 1 to 3.

The radicals R¹, R², R³, R⁴, R⁵, R⁶, R⁷, R⁸, R⁹, R¹⁰, R¹¹ and R¹² are, independently of one another, a radical selected from the group consisting of hydrogen, (C₁-C₂₄)-alkyl, (C₃-C₁₂)-cycloalkyl, (C₂-C₂₄)-alkenyl, (C₃-C₂₄)-cycloalkenyl, (C₅-C₂₀)-aryl, Si((C₁-C₂₄)-alkyl)₃, Si(C₁-C₂₄)-alkyl)₂(C₆-aryl), Si(C₁-C₂₄)-alkyl)(C₆-aryl)₂, Si(C₆-aryl)₃, S((C₁-C₂₄)-alkyl), S((C₅-C₂₀)-aryl), F, Cl, Br or I. The radicals R² and R⁴ and/or R¹ and R³, independently of one another, can also be linked with one another and the radicals R¹ to R¹² can also bear other substituents.

Metals of subgroup eight have proven useful as catalysts and should preferably be applied to a porous support, which can be present in powder or granule form. In general, catalysts should have a specific surface area between 0.1 m²/g and 5000 m²/g and preferably between 1 m²/g and 2500 m²/g. Particular preference is given to catalysts containing palladium, rhodium and/or ruthenium. Preferred porous supports are carbon supports, for example activated carbon, or aluminium oxide supports, for example Al₂O₃. When activated carbon supports are used they should, preferably, have a bulk density of between 100 and 450 g/l, and more preferably between 200 and 400 g/l. They should also have a specific surface area of between 700 and 2000 m²/g, and preferably between 900 and 1800 m²/g. Al₂O₃ supports have a preferred bulk density of between 200 and 800 g/l, and more preferably between 250 and 750 g/l. The preferred specific surface area of Al₂O₃ supports is between 2 and 300 m²/g, and more preferably between 5 and 250 m²/g. Particularly preferred catalysts are accordingly Pd/C, Ru/C, Pd/Al₂O₃ or Ru/Al₂O₃ the supports of which correspond to the specifications just described. Preferably, the catalyst is used in an amount in which the metal is present in a range from 0.01 mol % to 15 mol %, more preferably in an amount of 0.1 mol % to 10 mol %, and still more preferably in an amount between 0.5 mol % and 5 mol % of the amount of substrate.

Using the process described above, products of formula (II) are obtained in high yield under relatively mild reduction conditions, for example, at temperatures below 120° C. and an initial hydrogen pressure of less than 80 bar. The mild conditions appear to be the reason for the very good selectivity of the conversion to the H₈-1,1′-bi-2-naphthyl derivatives of formula (II); racemization of the products during preparation can be substantially or even completely avoided. A further advantage of the process is the good recyclability of the catalyst. For instance, the catalysts used in the examples can be recovered repeatedly and used again without substantial loss of activity. The process should therefore be of particular value for the industrial preparation of compounds of the formula (II). The recoverability of the catalyst could be due to the reaction conditions, for example the metal/support construction, the mild reaction conditions, or the omission of reaction additions which harm the catalyst, for example acids. Owing to the clean reaction conditions, workup of the resultant products is also very simple.

Preferably, the reduction method is carried out at temperatures of 30° C. to 100° C., particularly preferably from 40° C. to 70° C. The hydrogen pressure applied initially is preferably between 1 bar and 70 bar, particularly preferably between 10 bar and 50 bar.

Preferred starting materials for the reduction reaction are binaphthyl derivatives of the formula (I), in which the radicals X and Y are independently selected from the group OH, OR′, OCH₂OCH₃, OCH₂OCH₂CH₃, OCH₂OCH₂OCH₃, SH, SR′, NH₂, NHR′ and NR′R″, where R′ and R″ independently of one another are a (C₁-C₁₂)-alkyl or C₆-aryl radical. Preferred radicals R¹ to R¹² are independently selected from the group hydrogen, (C₁-C₁₂)-alkyl, (C₃-C₆)-cycloalkyl and C₆-aryl. Preference is given to the radicals R¹, R², R⁷ and R⁸ being substituents deviating from hydrogen. Particularly preferably, starting compounds are binaphthyl derivatives of the formula (I), the radicals R¹ to R¹² of which are hydrogen.

The individual radicals R′, R″ and R¹ to R¹² can each independently of one another bear further substituents which are preferably selected from the group H, OH, OR′, O—((CₙH₂ₙ)—O—)ₘR′″, NH₂, NHR′″, NR′″R″″, SH, SR′″, (C₁-C₂₄)-alkyl, (C₃-C₁₂)-cycloalkyl, (C₂-C₂₄)-alkenyl, (C₃-C₂₄)-cycloalkenyl, (C₅-C₂₀)-aryl, Si((C₁-C₂₄)-alkyl)₃, Si(C₁-C₂₄)-alkyl)₂(C₆-aryl), Si(C₁-C₂₄)-alkyl)(C₆-aryl)₂, Si(C₆-aryl)₃, S((C₁-C₂₄)-alkyl), S((C₅-C₂₀)— aryl), F, Cl, Br or I, the radicals R′″ and R“ ” having the meaning specified for R′ and R″, and the indices n and m having the meaning specified above.

Since aromatic substituents are generally likewise hydrogenated during the reduction, starting materials having unsaturated substituents or aryl substituents can be used for preparing the corresponding alkyl or cycloalkyl compounds. Conversely, it may be necessary to introduce reactive unsaturated or aromatic substituents after the reduction. In particular, independently of one another, the radicals R′, R″, R¹, R², R⁵, R⁶, R⁷, R⁸, R⁹, R¹⁰, R¹¹ and R¹² can be introduced after reduction has been performed. A number of known derivatization methods are available for carrying this out, as described, see, e.g., Cox et al., Tetrahedron Lett. 33(17): 2253-2256 (1992); Simonsen, et al., J. Org. Chem. 63: 7536-7538 (1998) or in WO 02/40491.

Using the method disclosed herein, enantioselectively enriched products of the formula (II) can be obtained, Preferably the desired products are achieved with an enantioselectivity (ee) of greater than 80%, and more preferably greater than 90 or 95%. In many cases, even virtually enantiomerically pure compounds can be obtained which have an enantiomeric purity of greater than 99%.

The compounds of the formula (II) obtained by the claimed method can be used, for example, as ligands in catalytic asymmetric reactions or polymerizations, in particular in asymmetric hydrogenation, asymmetric alkylation of aldehydes, or in hetero Diels-Alder reactions. Furthermore, they can serve as starting material for further derivatization in order to provide optimized ligands for such asymmetric catalytic reactions.

### EXAMPLES

General Comments Regarding Materials and Methods:

All starting compounds used are, where not stated otherwise, commercially available and were used without further purification. The NMR spectra recorded to characterize the products were recorded at 400.13 (¹H) MHz and 100.63 (¹³C) MHz using TMS as standard. The reported values of J are in Hz, and δ in ppm.

Chiral HPLC is carried out using a Chiralcel column, hexane/EtOH=90/10 (octa-hydrobinaphthols) or a Chiralcel column, hexane/EtOH=99.5/0.5 (3,3′-dimethyl-octahydrobinaphthols), or a (R,R)-Whelk-01 column; hexane/EtOH=99.95/0.05 (3,3′-dicyclohexyloctahydrobinaphthols).

### Examples 1 to 12

### Hydrogenation of Binaphthols

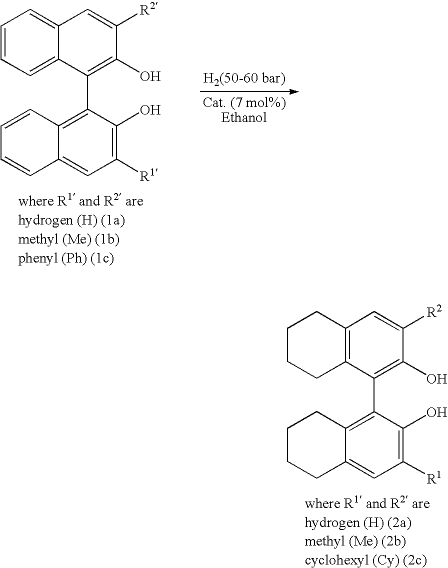

A. Synthesis of the Starting Materials (1b) and (1c):

Starting from BINOL, the compounds 1b and 1c were prepared in accordance with the protocol of Arnold, L. A., et al. (Tetrahedron Lett. 56: 2865-2878 (2000)).

B. Reduction of Substrates

0.438 g (1 mmol) of the substrate is placed in a 35 ml autoclave together with 0.3 g of 5% strength Pd/C (50% wet) and 10 ml of ethanol and stirred at 50 bar hydrogen pressure at 70° C. for 7 h. After 7 h, hydrogen consumption was no longer observable. The reaction mixture was cooled to room temperature. The catalyst was then filtered off and washed repeatedly with CH₂Cl₂ (3×10 ml). The resultant filtrates were combined and concentrated in vacuo. Analytically pure reduction product was obtained by means of flash chromatography (silica, CH₂C₁₂). NMR analysis of the product 2c shows that no product or product/starting material is present. Yield 100%, >99% ee Analytical data on (+)-(R)-3,3′-dicyclohexyl-5,5′,6,6′,7,7′,8,8′-octahydro-2,2′-dihydroxy-1,1′-dinaphthyl (2c):

mp 118-120° C.;

[α]_{D}²⁵+41.7 (c=1, CH₂Cl₂); EI-MS m/z 458 (M⁺, 100);

¹H NMR (400 MHz, CDCl₃)

δ6.89 (s, 2H), 4.55 (s, 2H), 2.80 (m, 2H), 2.65 (m, 4H), 2.00-2.19 (m, 4H), 1.71-1.89 (m, 8H), 1.53-1.70 (m, 10H), 1.34 (m, 8H), 1.18 (m, 2H);

¹³C NMR (100 MHz, CDCl₃) δ149.0, 134.3, 132.1, 129.9 (all C), 128.5 (CH), 119.2 (C), 37.7 (CH), 33.6, 29.8, 27.5, 27.3, 26.9, 23.6 (all CH₂). Anal. Calcd. for C₃₂H₄₂O₂: C, 83.79; H, 9.23. Found: C, 83.08; H, 9.62.

Similarly to b), further reductions were carried out using different substrates and catalysts. The results are summarized in Table 1.

TABLE 1
Results of Catalytic Hydrogenation of Substrates 1a, 1b, 1c.

| | | | | Reaction | | |
|---|---|---|---|---|---|---|
| Ex. | | | T | time | Yield | ee |
| No. | Substrate | Catalyst | (in ° C.) | (in hours) | (in %) | (in %) |
| 1 | 1a | Ru/Al₂O₃ | 100 | 3 | 100 | 97.2 |
| 2 | 1a | Ru/C | 50 | 1.5 | 98 | >99 |
| 3 | 1a | Ru/C | 70 | 0.5 | 98 | >99 |
| 4 | 1a | Pd/C | 50 | 2.5 | 99 | >99 |
| 5 | 1a | Pd/C | 70 | 0.5 | 99 | >99 |
| 6 | 1b | Ru/Al₂O₃ | 100 | 2 | 100 | 99.0 |
| 7 | 1b | Ru/C | 50 | 7 | 99 | >99 |
| 8 | 1b | Ru/C | 70 | 0.5 | 97 | >99 |
| 9 | 1b | Pd/C | 70 | 0.5 | 98 | >99 |
| 10 | 1c | Ru/C | 70 | 7 | 96 | 98.5 |
| 11 | 1c | Pd/C | 70 | 7 | 100 | >99 |
| 12 | 1c | Pd/C | 100 | 0.75 | 100 | 99.0 |

The results indicate that, in the reduction of BINOL and BINOL derivatives with the catalysts used, the desired products are obtainable in high enantioselectivity at high yields. Pd- and Ru-containing catalysts based on a carbon support permit a reaction at low temperature, but also the reaction using catalysts based on aluminium oxide leads to very good results, with no racemization being observable, even at a reaction temperature of 100° C. No significant differences are observable with respect to the catalytic activity of the palladium and ruthenium used.

Using the Pd/C or Ru/C catalysts, virtually quantitative results can be achieved in the conversion of 1a and 1b after 30 minutes at a temperature of 70° C. Longer reaction times are necessary in the reduction of 1c, which may be due to the additional phenyl radicals which are likewise reduced under the given conditions. Analysis of the products using chiral HPLC showed that the products obtained were not subject to significant racemization during reduction; products 2a, 2b, 2c were obtained with an enantioselectivity of >99% ee.

### Examples 13 to 19

### Hydrogenation of Dialkoxybinaphthyl Derivatives

3,3′-Disubstituted chiral H₈-BINOLs 2a, 2b, 2c can likewise be obtained by hydrogenating the corresponding bis-methylated compounds 3a, 3b, 3c with subsequent demethylation. Hydrogenation of the 2,2-dimethoxybinaphenyl derivatives is carried out according to the procedure in Example 1b). The protecting groups are then removed, adding BBr₃, from the 2,2′-dimethoxy-1,1′-binaphthyl derivatives 4a, 4b, 4c obtained in the reduction.

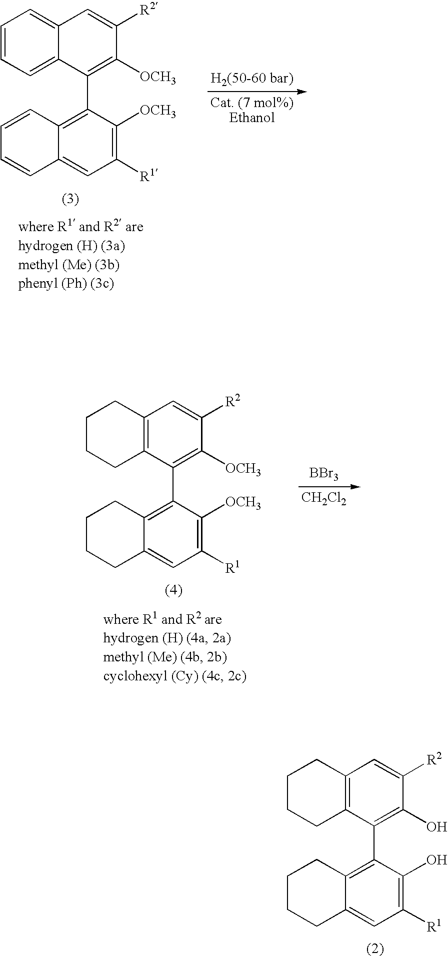

The hydrogenation proceeds with quantitative yields, but with somewhat longer reaction times compared with Example 1. The products 2a, 2b and 2c obtained after deprotection are racemized to a small extent; the products contain 1-5% of the enantiomer resulting from racemization. The results of the reactions are reproduced in Table 2.

TABLE 2
Catalytic reduction of the 2,2′-dimethoxybinaphthyls 2a, 2b, 2c.

| Ex. | | | T | Reaction time | Yield^{a} | ee^{b} |
|---|---|---|---|---|---|---|
| Nr. | Substrate | Catalyst | (in ° C.) | (in hours) | (in %) | (in %) |
| 13 | 3a | Ru/C | 100 | 0.5 | 74 | 95.4 |
| 14 | 3a | Pd/C | 50 | 3 | 80 | 97.0 |
| 15 | 3a | Pd/C | 70 | 1.5 | 77 | 97.2 |
| 16 | 3b | Ru/C | 100 | 1.5 | 71 | 93.3 |
| 17 | 3b | Pd/C | 100 | 1 | 75 | 90.2 |
| 18 | 3c | Ru/C | 100 | 0.5 | 69 | 98.8 |
| 19 | 3c | Pd/C | 100 | 1 | 74 | 98.5 |

^{a}Yield of deprotected binaphthol 2a, 2b, 2c.
^{b}Determined by chiral HPLC of the deprotected binaphthols 2a, 2b, 2c.

### Example 20

### Reduction of Diaminobinaphthyl Derivatives

(R)-2,2′-Diamino-1,1′-binaphthyl derivatives of the formula 5a are hydrogenated to the corresponding H₈ derivatives 6a at 100° C. using a Pd/C catalyst (7 mol % of Pd based on the substrate) in 30 min.

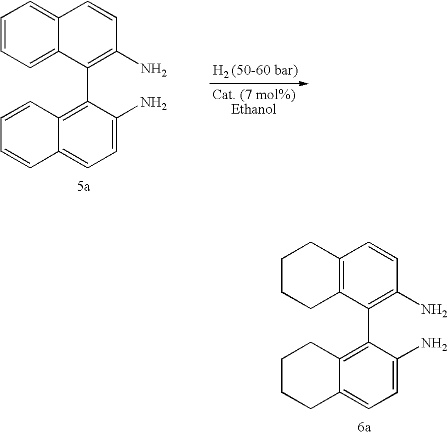

The reaction proceeds quantitatively (yield 97% based on the starting compound), and no racemization of the products obtained was observed using chiral HPLC (>99% ee).

### Example 21

### Preparation of (R)—H⁸-BINOL 2a by Reduction of Compound 1a on a Preparative Scale

To investigate the industrial suitability of the method, a larger batch of 20 g of compound 1a was reacted at 100° C. and an initial hydrogen pressure of 80 bar in the presence of a Pd/C catalyst. 20.0 g (70 mmol) of compound 1a, 2.97 g of 5% strength Pd/C (50% wet) and 100 ml of ethanol were placed in a 300 ml autoclave and stirred under a hydrogen pressure of 80 bar at 100° C. for 5.5 h. The reaction mixture was then cooled to room temperature, the catalyst filtered off and the reaction mixture was washed repeatedly with ethanol (3×50 ml). The resultant filtrates were combined and concentrated in vacuo. 20.1 g (98% yield) of spectrometrically pure (R)-H⁸-BINOL 2a (white solid/99.7% ee) were obtained.

### Example 21

### Catalyst Recycling

To determine the recyclability of the catalyst, the following reaction is carried out repeatedly.

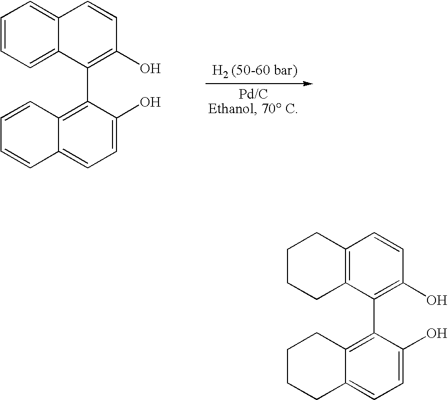

The catalyst used is a 5% strength palladium catalyst on activated carbon (Degussa AG, type E 10 R). The reaction and recovery of the catalyst are carried out in a similar manner to the instructions from Example 1 b. The results of the reaction are summarized in Table 3.

TABLE 3
Catalyst Recycling

| Reaction | Reaction time | Yield (%) | ee (%) |
|---|---|---|---|
| 1 | 60 | 99 | >99 |
| 2 | 80 | 98 | >99 |
| 3 | 70 | 100 | >99 |
| 4 | 60 | 98 | >99 |
| 5 | 60 | 99 | >99 |

Even after 5 reactions (4 recycling cycles), no loss of activity of the catalyst was observed.

All references cited herein are fully incorporated by reference. Having now fully described the invention, it will be understood by those of skill in the art that the invention may be practiced within a wide and equivalent range of conditions, parameters and the like, without affecting the spirit or scope of the invention or any embodiment thereof.

1. A method for the reduction of binaphthyl derivatives of the formula (I), 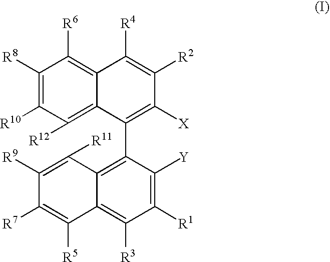
to give H₈-1,1′-bi-2-naphthyl derivatives of the formula (II) 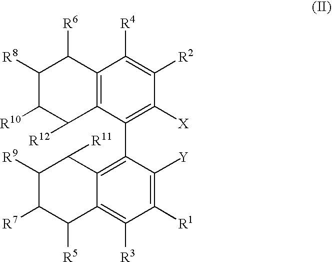
wherein said binaphthyl derivatives are reacted with hydrogen in the presence of a catalyst comprising at least one metal selected from the group consisting of: Pt; Ir; Os; Pd; Rh; Ru; Ni; Co; and Fe; said metal being applied to a solid support,
and wherein:
a) X and Y are, independently of one another, a radical selected from the group consisting of: OH; OR′; O—((CₙH₂ₙ)—O—)ₘR′; NH₂; NHR′; NR′R″; SH; and SR′; wherein:
i) R′ and R″ are, independently of one another, selected from the group consisting of: hydrogen; (C₁-C₂₄)-alkyl; (C₃-C₁₂)-cycloalkyl; (C₂-C₂₄)-alkenyl; (C₃-C₂₄)-cycloalkenyl; or (C₅-C₂₀)-aryl radical;
ii) the radicals R′ and R″ can optionally also bear other substituents;
iii) n is an integer from 1 to 24, preferably from 1 to 6;
iv) m is an integer from 1 to 12, preferably from 1 to 3; and
b) R¹, R², R³, R⁴, R⁵, R⁶, R⁷, R⁸, R⁹, R¹⁰, R¹¹ and R¹² are, independently of one another, a radical selected from the group consisting of: hydrogen; (C₁-C₂₄)-alkyl; (C₃-C₁₂)-cycloalkyl; (C₂-C₂₄)-alkenyl; (C₃-C₂₄)-cycloalkenyl; (C₅-C₂₀)— aryl; Si((C₁-C₂₄)-alkyl)₃; Si(C₁-C₂₄)-alkyl)₂(C₆-aryl); Si(C₁-C₂₄)-alkyl)(C₆-aryl)₂; Si(C₆-aryl)₃; S((C₅-C₂₄)-alkyl); S((C₅-C₁₀)-aryl); F; Cl; Br; or I; and wherein:
i) independently of one another, R² may be linked to R⁴ and R¹ may be linked to R³; and
ii) R¹ to R¹² can also optionally bear other substituents.

2. The method of claim 1, wherein said other substituents for the radicals R′ and R″ referred to in paragraph a) ii) and said other substituents for R¹ to R¹² are selected from the group consisting of: hydrogen; OH; OR′; O—((CₙH₂ₙ)—O—)ₘR′″; NH₂, NHR′″; NR′″ R“ ”; SH; SR′″; (C₁-C₂₄)-alkyl; (C₃-C₁₂)-cycloalkyl; (C₂-C₂₄)-alkenyl; (C₃-C₂₄)-cycloalkenyl; (C₅-C₂₀)-aryl; Si((C₁-C₂₄)-alkyl)₃; Si(C₁-C₂₄)-alkyl)₂(C₆-aryl); Si(C₁-C₂₄)-alkyl)(C₆-aryl)₂; Si(C₆-aryl)₃; S((C₁-C₂₄)-alkyl); S((C₅-C₂₀)-aryl); F; Cl; Br; and I; and wherein the radicals R′″ and R″″ are selected from the group consisting of: hydrogen; (C₁-C₂₄)-alkyl; (C₃-C₁₂)-cycloalkyl; (C₂-C₂₄)-alkenyl; (C₃-C₂₄)-cycloalkenyl; and (C₅-C₂₀)-aryl radical.

3. The method of claim 2, wherein said other substituents for the radicals R′ and R″ referred to in paragraph a) ii) and said other substituents for R¹ to R¹² are selected from the group consisting of: hydrogen; OH; OR′; NH₂, SH; (C₁-C₂₄)-alkyl; (C₃-C₁₂)-cycloalkyl; (C₂-C₂₄)-alkenyl; (C₃-C₂₄)-cycloalkenyl; (C₅-C₂₀)-aryl; Si((C₁-C₂₄)-alkyl)₃; Si(C₁-C₂₄)-alkyl)₂(C₆-aryl); Si(C₁-C₂₄)-alkyl)(C₆-aryl)₂; Si(C₆-aryl)₃; S((C₁-C₂₄)-alkyl); S((C₅-C₂₀)-aryl); F; Cl; Br; and I.

4. The method of claim 2, wherein said other substituents for the radicals R′ and R″ referred to in paragraph a) ii) and said other substituents for R¹ to R¹² are selected from the group consisting of: hydrogen; OH; OR′; NH₂, SH; F; Cl; Br; and I.

5. The method of claim 2, wherein said other substituents for the radicals R′ and R″ referred to in paragraph a) ii) and said other substituents for R¹ to R¹² are all hydrogen.

6. The method of claim 1, wherein n is an integer from 1 to 6 and m is an integer from from 1 to 3.

7. The method of any one of claims 1-6, wherein said metal is applied to a porous support having a specific surface area of between 0.1 m²/g and 5000 m²/g.

8. The method of any one of claims 1-6 wherein said metal is applied to an activated carbon support or aluminium oxide support.

9. The method of any one of claims 1-6, wherein said reduction is carried out at a temperature of below 120° C.

10. The method of claim 9, wherein said reduction is carried out at a temperature of 30° C. to 100° C.

11. The method of any one of claims 1-6, wherein said reduction is carried out at an initial hydrogen pressure of less than 80 bar.

12. The method of claim 11, wherein said reduction is carried out at an initial hydrogen pressure of less than 60 bar.

13. The method of any one of claims 1-6 wherein:
a) said metal is applied to an activated carbon support or aluminium oxide support having a specific surface area of between 0.1 m²/g and 5000 m²/g;
b) said reduction is carried out at a temperature of below 120° C.;
c) said reduction is carried out at an initial hydrogen pressure of less than 80 bar.

14. The method of claim 13, wherein said reduction is carried out at a temperature of 30° C. to 100° C. and at an initial hydrogen pressure of less than 60 bar.

15. The method of any one of claims 1-6, wherein X and Y are each independently selected from the group consisting of: OH; OR′; OCH₂OCH₃; OCH₂OCH₂CH₃; OCH₂OCH₂OCH₃; SH, SR′; NH₂; NHR′; and NR′R″; and wherein R′ and R″ are each independently selected from the group consisting of: (C₁-C₁₂)-alkyl, (C₃-C₆)— cycloalkyl and C₆-aryl.

16. The method of claim 15 wherein at least one of the radicals R¹ to R¹² independently of one another is selected from the group consisting of: hydrogen; (C₁-C₁₂)-alkyl; (C₃-C₆)-cycloalkyl; and C₆-aryl.

17. The method of claim 16 wherein:
a) said metal is applied to an activated carbon support or aluminium oxide support having a specific surface area of between 0.1 m²/g and 5000 m²/g;
b) said reduction is carried out at a temperature of below 120° C.;
c) said reduction is carried out at an initial hydrogen pressure of less than 80 bar.

18. The method of any one of claims 1-6, wherein R¹-R¹² are hydrogen.

19. The method of claim 18, wherein X and Y are each independently selected from the group consisting of: OH; OR′; OCH₂OCH₃; OCH₂OCH₂CH₃; OCH₂OCH₂OCH₃; SH, SR′; NH₂; NHR′; and NR′R″; and wherein R′ and R″ are each independently selected from the group consisting of: (C₁-C₁₂)-alkyl, (C₃-C₆)-cycloalkyl and C₆-aryl.

20. The method of claim 19 wherein:
a) said metal is applied to an activated carbon support or aluminium oxide support having a specific surface area of between 0.1 m²/g and 5000 m²/g;
b) said reduction is carried out at a temperature of below 120° C.;
c) said reduction is carried out at an initial hydrogen pressure of less than 80 bar.
